(19) United States
(12) Patent Application Publication
(10) Pub. No.: US 2012/0148199 A1
(43) Pub. Date: Jun. 14, 2012

(54) OPTICAL FIBER CONNECTOR

(75) Inventors: TAI-CHERNG YU, Tu-Cheng (TW); I-THUN LIN, Tu-Cheng (TW)

(73) Assignee: HON HAI PRECISION INDUSTRY CO., LTD., Tu-Cheng (TW)

(21) Appl. No.: 12/979,246

(22) Filed: Dec. 27, 2010

(30) Foreign Application Priority Data
Dec. 14, 2010 (TW) 99143588

(51) Int. Cl. G02B 6/36

(52) U.S. Cl. 385/79

(57) ABSTRACT

An optical fiber connector includes a number of optical fibers, a body, a number of supports and a cover. The body includes a number of lens portions at a first end thereof, a number of through holes at an opposite second end, and a recess located between the lens portions and the through holes. The through holes are in communication with the recess. The optical fibers extend through the respective through holes and terminate at the respective lens portions. The supports are formed in the recess. Each support supports and retains a portion of the corresponding optical fiber exposed in the recess. The cover is inserted in the recess. The cover and the supports cooperatively securely sandwich the exposed portions of the optical fibers in the body.

### BACKGROUND

1. Technical Field

The present disclosure relates to optical fiber connectors.

2. Description of Related Art

Optical fiber connectors typically include a lens and a blind hole behind the lens. The blind hole receives an optical fiber. The lens receives and guides light from the optical fiber.

Injection molding is a current molding method for molding optical fiber connectors. A mold used in injection molding includes a core pin used to mold the blind hole. During the injection molding process, the core pin may be bent by impact of introduced molding material, thus producing a blind hole out of spec.

Therefore, an optical fiber connector, which can overcome the above-mentioned problems, is needed.

### BRIEF DESCRIPTION OF THE DRAWINGS

FIG. 1 is a schematic view of an optical fiber connector, according to a first embodiment.

FIG. 2 is a partially exploded view of the optical fiber connector of FIG. 1.

FIG. 3 is a sectional view of the optical fiber connector taken along line of FIG. 2.

FIG. 4 is an enlarged view of circled portion IV of FIG. 3.

FIG. 5 is a sectional view of an optical fiber connector, according to a second embodiment.

### DETAILED DESCRIPTION

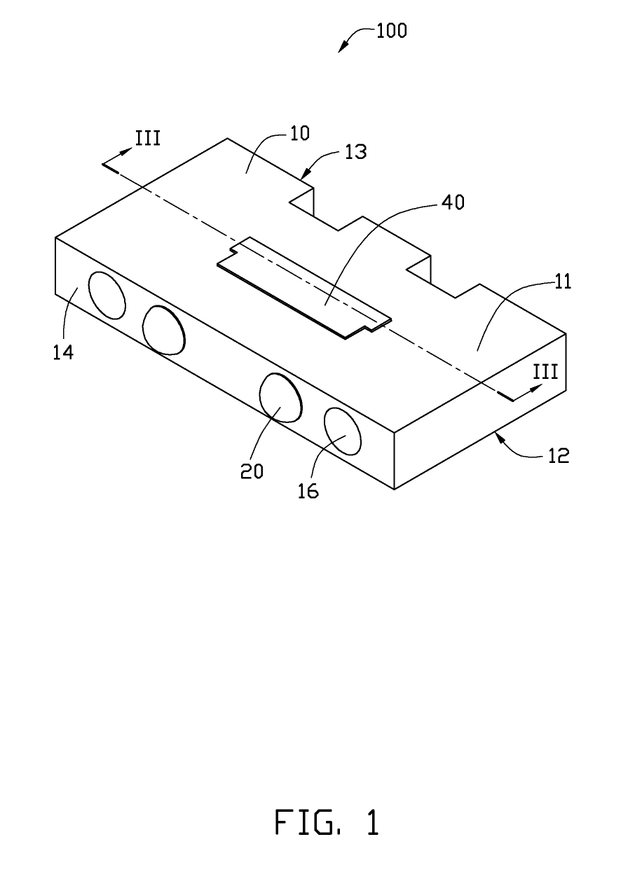

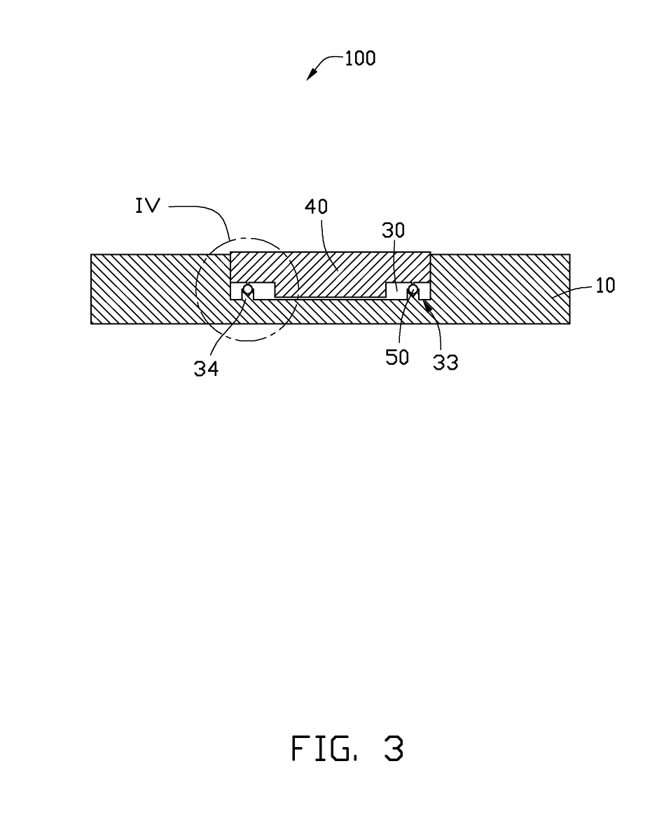

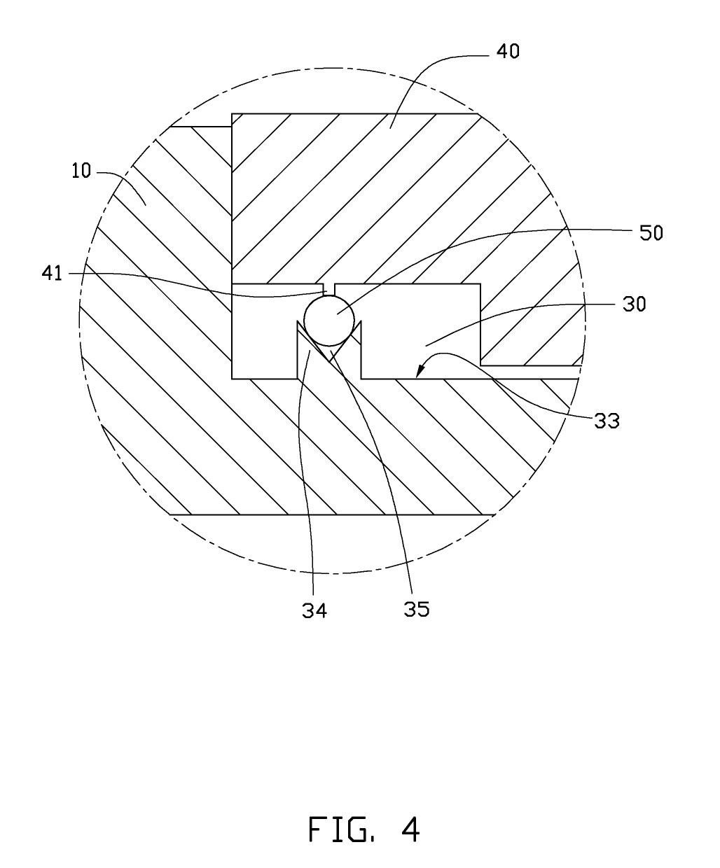

Referring to FIGS. 1 to 4, an optical fiber connector 100, according to a first embodiment, includes a body 10, a cover 40, and two optical fibers 50.

The body 10 is substantially cuboid and includes a first end 14, an opposite second end 13, a first side surface 11, and a second side surface 12 opposite to the first side surface 11. The first side surface 11 and the second side surface 12 connect the first end 14 to the second end 13. Two lens portions 20 are formed at the first end 14. Two insertion holes 16 are defined at the first end 14. The two lens portions 20 are located between the two insertion holes 16. The insertion holes 16 are configured for positioning the body 10 in place when the optical fiber connector 10 is coupled to another optical fiber connector. The body 10 may be formed by injection molding.

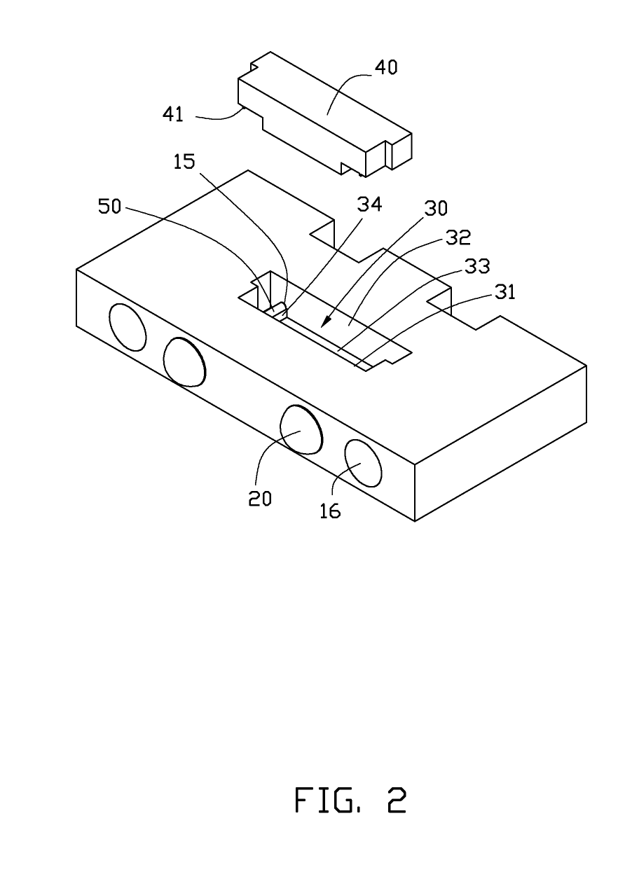

The body 10 defines two through holes 15 (only one through hole 15 is visible in FIG. 2) and a recess 30. The through holes 15 are defined at the second end 13 and respectively receive the optical fibers 50. Each of the optical fibers 50 has a portion (not labeled) exposed in the recess 30. The two through holes 15 are parallel to each other and are aligned with the lens portions 20 respectively. The through holes 15 extend from the second end 13 to the first end 14 and are in communication with the recess 30. The recess 30 is located between the lens portions 20 and the through holes 15. The optical fibers 50 extend through the respective through holes 15 and terminate at the respective lens portions 20. The body 10 includes a first inner surface 31, a second inner surface 32 and a bottom surface 33 in the recess 30. The first inner surface 31 is opposite to the second inner surface 32. The bottom surface 33 connects the first inner surface 31 to the second inner surface. The through holes 15 extend through the second inner surface 32. In this embodiment, the first inner surface 31 coincides with a focal plane of the lens 20. It is to be understood that in alternative embodiments, the first inner surface 31 may be positioned in a plane parallel to the focal plane of the lens 20.

Two strip-shaped supports 34 are formed in the recess 30 and protrude from the bottom surface 33. Each support 34 supports and retains the portion of the corresponding optical fiber 50 exposed in the recess 30. The support 34 connects the second inner surface 32 to the first inner surface 31. Specifically, a V-shaped groove 35 is defined in each of the supports 34 and is in communication with the through hole 15. The grooves 35 are parallel to each other. The exposed portions of the optical fibers 50 are supported in the grooves 35. Ends of the optical fibers 50 distal from the second inner surface 32 are in contact with the first inner surface 31.

The cover 40 is shaped to be inserted in the recess 30 and may be secured in the recess 30 by adhesive. Material of the cover 40 may be transparent to ultraviolet light so that the adhesive can be cured by ultraviolet light. An insertion direction of the cover 40 is substantially perpendicular to an extending direction of the through hole 15. The cover 40 includes two strip-shaped protrusions 41 formed on a surface thereof facing the supports 34 and the bottom surface 33. Each of the protrusions 41 is aligned with the corresponding groove 35. The protrusions 41 respectively abut against the exposed portions of the corresponding optical fibers 50 so that the supports 34 and the cover 40 cooperatively securely sandwich the exposed portions of the optical fibers 50 in the body 10. Therefore, cooperation of the supports 34 and the protrusions 41 can function as blind holes and the blind holes for receiving the optical fibers 50 are omitted, making it is easier to mold the body 10 to desired tolerances with supports 34 and the cover 40 with protrusions 41 than to mold a body with blind holes to desired tolerances.

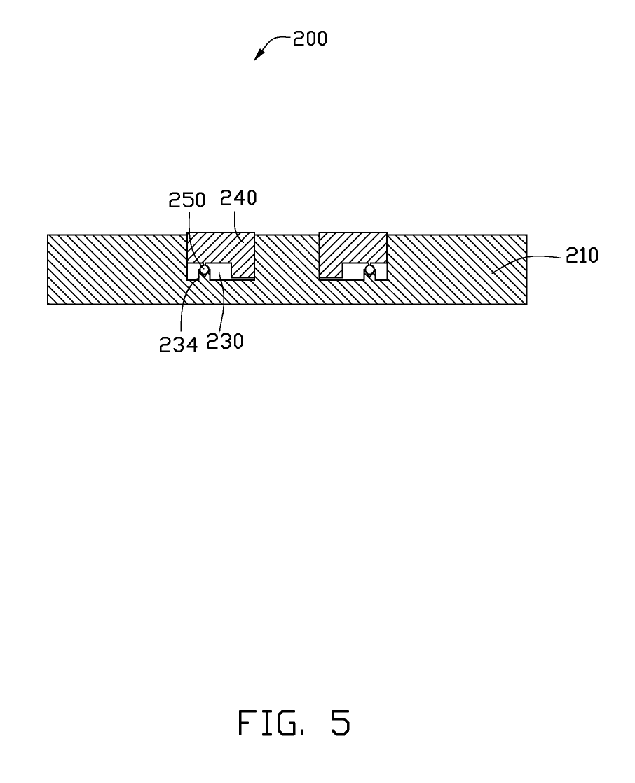

Referring to FIG. 5, an optical fiber connector 200, according to a second embodiment, is shown. Differences between the optical fiber connector 200 and the optical fiber connector 100 of the first embodiment are that the optical fiber connector 200 includes two covers 240 and a body 210 of the optical fiber connector 200 defines two recesses 230.

Each of the covers 240 is shaped to be inserted in a corresponding recess 230. A support 234 is formed in each recess 230. The supports 234 and the covers 240 cooperatively securely sandwich portions of the optical fibers 250 exposed in the respective recesses 230.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An optical fiber connector, comprising:
a plurality of optical fibers;
a body comprising a plurality of lens portions at a first end thereof, a plurality of through holes at an opposite second end, and a recess located between the lens portions and the through holes, the through holes being in communication with the recess, the optical fibers extending through the respective through holes and terminating at the respective lens portions;
a plurality of supports formed in the recess, each support supporting and retaining a portion of the corresponding optical fiber exposed in the recess; and
a cover inserted in the recess, the cover and the supports cooperatively securely sandwiching the exposed portions of the optical fibers in the body.

2. The optical fiber connector of claim 1, wherein the through holes are parallel to each other, and an insertion direction of the cover is substantially perpendicular to an extending direction of the through hole.

3. The optical fiber connector of claim 1, wherein the body comprises a bottom surface in the recess, the supports protruding from the bottom surface.

4. The optical fiber connector of claim 1, wherein a V-shaped groove is defined in each of the supports, the exposed portions of the optical fibers supported in the grooves.

5. The optical fiber connector of claim 4, wherein the cover comprises a plurality of strip-shaped protrusions, the protrusions aligned with the respective grooves and abutting against the exposed portions of the corresponding optical fibers.

6. The optical fiber connector of claim 4, wherein the V-shaped grooves are parallel to each other.

7. An optical fiber connector, comprising:
a plurality of optical fibers;
a body comprising a plurality of lens portions at a first end thereof, a plurality of through holes at an opposite second end, and a plurality of recesses located between the lens portions and the through holes, the optical fibers extending through the respective through holes and terminating at the respective lens portions, each of the optical fibers having a portion exposed in the corresponding recess;
a plurality of supports formed in the corresponding recesses, each of the supports supporting the exposed portion of the corresponding optical fiber; and
a plurality of covers each inserted in the corresponding recess, the covers and the supports cooperatively sandwiching the exposed portions of the respective optical fibers in the body.

8. The optical fiber connector of claim 7, wherein the through holes are parallel to each other, and insertion directions of the covers are substantially perpendicular to an extending direction of the through hole.

9. The optical fiber connector of claim 7, wherein the body comprises two bottom surfaces in the respective recesses, the supports protruding from the respective bottom surfaces.

10. The optical fiber connector of claim 7, wherein a V-shaped groove is defined in each of the supports, the exposed portions of the optical fibers supported in the grooves.

11. The optical fiber connector of claim 10, wherein each of the covers comprises a strip-shaped protrusion, the protrusion aligned with the respective groove and abutting against the exposed portion of the corresponding optical fiber.

12. The optical fiber connector of claim 10, wherein the V-shaped grooves are parallel to each other.
